(19) United States
(12) Patent Application Publication
(10) Pub. No.: US 2009/0125155 A1
(43) Pub. Date: May 14, 2009

(54) Method and System for Optimizing Industrial Furnaces (Boilers) through the Application of Recursive Partitioning (Decision Tree) and Similar Algorithms Applied to Historical Operational and Performance Data

(76) Inventors: Thomas Hill, Tulsa, OK (US); Pawel Lewicki, Tulsa, OK (US)

Correspondence Address: Dr. Thomas Hill;c/o StatSoft Inc., 2300 East 14'th Street, Tulsa, OK, 74104, US

(21) Appl. No.: 12/034,390

(22) Filed: Feb. 20, 2008

Related U.S. Application Data
(60) Provisional application No. 61/002,178, filed on Nov. 8, 2007.

(51) Int. Cl. G06F 17/00

(52) U.S. Cl. 700/286

(57) ABSTRACT

A method is provided for deriving optimized operating parameter settings for industrial furnaces of different designs as commonly used in power generation that will achieve robust and desirable operations (for example, low NOx and low CO emissions while maintaining specific furnace exit gas temperatures). The method includes the application of recursive partitioning algorithms to historical process data to identify critical combinations of ranges of operational parameter (combinations of settings) that will result in robust (low-variability) desirable (optimized) boiler performance, based on empirical evidence in the historical data. The method may include the application of various algorithms for recursive partitioning of data, as well as the consecutive application of recursive partitioning methods to prediction residuals of previous models (a methodology also known as boosting), as well as the application of other prediction algorithms that rely on the partitioning of data (support vector machines, naive Bayes classifiers, k-nearest neighbor methods).

### CROSS-REFERENCE TO RELATED APPLICATIONS

This application claims the benefit of U.S. Provisional Application No. 61/002,178 filed on Nov. 8, 2007.

### TECHNICAL FIELD

This disclosure relates generally to computer based mathematical modeling and optimization methods and systems for identifying desired operational parameter ranges from historical process data, that will optimize important performance characteristics of industrial boilers.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND

The invention described here identifies a computer analysis and modeling-based methodology and system for optimizing industrial boilers of various designs and related systems, as used in electrical power plants, for stable and improved operations.

Unlike other methodologies for boiler optimization, based on computational fluid dynamics methodologies (see for example, Babcock & Wilcox, 2007, Steam: It's generation and use; 41st Edition), the methodology described in this invention is based on actual observed data, as they are commonly recorded into process databases (process “historians”) at power plants of all types and designs.

The invention is particularly applicable, but not limited to, various fossil fuel (gas, oil, and coal) furnaces of various types of designs, including but not limited to pulverized coal (PC) furnaces, cyclone furnaces, wall-fired furnaces, tangentially-fired (T-fired) furnaces, atmospheric pressure fluidized-bed boilers, and coal gasification furnaces, to achieve optimal and stable low-emissions operations (e.g., low NOx and Co), while maintaining other critical performance parameters (e.g., furnace exit gas temperatures), in the presence of normally occurring variability in operational parameters not under direct digital control system or operator control (e.g., load and fuel flow, fuel quality, environmental variables).

The invention is also applicable to the optimization of related systems for environmental and emissions control, including but not limited to selective catalytic reduction (SCR) systems and selective non-catalytic reduction (SNCR) systems, overfire air (OFA) systems, electro-static precipitators (ESP), and other systems commonly found in power plants, to control and lower emissions.

The invention allows for the identification of operational control parameter ranges, that can be implemented into existing automatic or manual control systems, that will improve the performance of the furnaces and related equipment, without the need to apply expensive (hardware-based) modifications. By refining the operating guidelines and control system rules and algorithms to be consistent with the recommendations extracted from historical process data via the methodology disclosed in this invention, sustained overall operational improvements can be achieved, including but not limited to reductions of undesirable (harmful) emissions, significantly lower operating and maintenance costs, as well as greater system reliability (availability of capacity).

The processes discussed here, such as the operation of coal-fired furnaces, to which the invention disclosed here can be applied, have a number of common characteristics that make the analyses of historical process data—for the purposes of process optimization—difficult and challenging. For example:
1. In a typical coal-burning power plant, a large number of parameters are measured and recorded to describe all aspects of the process, from the quality characteristics of the fuels that go into the burners, the parameters that determine the details of the operations of the furnace itself, and parameters that determine the details of the operation of auxiliary equipment for controlling emissions, avoiding reliability problems, and so on. All of these measurements are taken continuously (e.g., every minute) and parameters measured or set (by operators or the digital control system) upstream of the process will effect in often complex ways the parameters at points downstream of the process. The data collected to describe such a process are difficult to analyze, because of complex autocorrelations across varying time intervals, nonlinear effects and interactions, and so on. In addition, there are typically hundreds if not thousands of process parameters and their interactions that will determine critical performance indicators of power plants, including flame temperatures in cyclones, undesirable emissions (e.g., of NOx and CO), and process efficiencies.
2. Continuous processes are usually supervised, sometimes partially through closed-loop automatic control systems, partially by experienced operators; however, the parameter settings (of processing equipment) set by operators are themselves the result of specific processing conditions (parameter settings) upstream of the process, creating strong autocorrelations in the process data. Therefore, it is not possible to independently change individual process parameters, without also changing (through autocorrelation of parameters) other parameters downstream at an unknown time interval. This makes it virtually impossible to apply traditional time-series based (linear or nonlinear) predictive modeling techniques, or common DOE (Design of Experiments) methods, or simple simulation based methods, with the goal to optimize the process.
3. Continuous processes generate a number of desirable and undesirable outcomes, such as electricity and emissions from burning fossil fuels to produce electricity. These outcomes are not independent of each other, but related to each other in complex ways, and related to upstream parameter settings in complex ways. The application of traditional data modeling and predictive analysis methodology assumes clear identification of predictors (exogenous variables) of the system, and outcomes that depend on the predictors; in continuous industrial processes, this distinction can usually not be made.

### SUMMARY OF THE INVENTION

The invention described here specifies an analytic procedure and workflow that is effective for optimizing continuous processes, and specifically the operation of fossil-fuel (e.g., coal) and other furnaces for consistent high quality (e.g., low-emissions) operations.

One aspect of the invention disclosed here pertains to the specific method of processing data extracted from historical data, describing the historical operation of one or more boiler(s) and a plurality of operational parameters, so as to identify those specific operational parameters that are most strongly related to high-quality (optimal) boiler performance, and distinguishing said operational parameters from those that are not related to high-quality (optimal) boiler performance.

Another aspect of the invention disclosed here pertains to the specific method of applying recursive partitioning computer algorithms, and other computer-based predictive data mining and optimization algorithms, to identify specific operational parameter ranges for a plurality of operational parameters, where, based on the empirical evidence in the historical data, high-quality (optimal) boiler performance has actually occurred, where near-high-quality (near-optimal) boiler performance has actually occurred, or where high-quality (optimal) boiler performance is likely to occur, in the presence of normally occurring ranges of values for those operational parameters not under direct operator or control system control (e.g., desired load, fuel quality, etc.)

### DETAILED DESCRIPTION OF THE INVENTION

This disclosure relates generally to computer based analysis and modeling techniques and, more particularly, to methods and systems for identifying desired operational parameter ranges for achieving desirable performance of industrial furnaces and boilers as commonly used in the power industry for the generation of electricity.

The specific steps of the analytic procedure and system disclosed in this patent are:
1. Extraction of all data describing the process; typically, this involves the extraction of a large amount of data (parameters and data points) from continuous process data bases, to describe historical (e.g., several years) of normal operations
2. Preparation of data to exclude obvious data recording errors
3. Identification of an appropriate aggregation interval; at this step, standard autocorrelation analyses are applied to the process data to identify an aggregation interval where the autocorrelation of adjacent aggregated values for identical process parameters will not exceed some specific value (e.g., 0.95).
4. The definition of one or more key performance indicators (in the data) that are to be optimized (e.g., measured NOx and CO emissions, flame temperatures, furnace gas exit temperatures, etc.)
5. The aggregation of the key performance indicators into a single quality index reflecting the overall quality based on all individual performance indicators; at this step, either simple numeric averages can be computed (e.g., average flame temperatures across cyclone furnaces), rank-order based performance indices can be created (, e.g., ranging form “11=unacceptable performance”, to “5=acceptable performance in full compliance with existing environmental regulation and mandates”), or discrete indicators of quality performance can be created (e.g., “0=unacceptable”, “1=acceptable”)
   5.1. Different methods, as described above, for aggregating key performance indicators are usually tried throughout the analytic process and steps, so as to identify a method that will yield in the subsequent steps (described below) a satisfactory solution, where sufficient evidence exists in the historical data that acceptable performance can be achieved given the respective solution (e.g., computed via recursive partitioning algorithms).
   5.2. The process of computing various aggregated performance indicators as described here, and performing the subsequent analyses on those performance indicators, can be automated via a computer program that will attempt various methods for aggregation, and select the one that produces the best result.
6. The application of one or more recursive partitioning algorithms (any of the available algorithms, as described below, are applicable) along with cross-validation methods to identify input parameter settings that are associated with desirable boiler performance.
   6.1. In this process, the identification of surrogate parameters (surrogate splits) and alternative recursive-partitioning models, to achieve the largest possible pool of combinations of possible parameter settings associated with desirable (optimized) process performance.
   6.2. In this process, the identification of parameters that are proxy-measurements of other external parameters outside operator control; for example, in applications with coal burning furnaces for power generation, when the power generating equipment is operated over a wide load range, many of the parameters that are associated with key performance indicators (NOx and CO emissions) are actually directly related to the power load under which the equipment is operated. Hence, to achieve a robust optimized solution (e.g., robust to load settings), it is critical that the multitude of recursive partitioning solutions is applied to such external uncontrollable parameters, to eliminate optimized parameter (recursive partitioning) solutions that cannot be achieved when those parameters (not under the control of the operator) vary widely.
7. Relating the results of the application of the recursive partitioning or other algorithm back to the historical data, to determine optimized operational parameter ranges that are both realistic (can be achieved in real operations), and for which there is evidence (of the ranges having been achieved) in the historical data.
   7.1 This is achieved by selecting from among the multitude of results nodes created through the application of recursive partitioning algorithms those nodes (subsets of data) where the highest mean performance index is achieved, along with the smallest variability (standard deviation) in that index.
   7.2. For most algorithms, such as the classification and regression tree algorithm (described under Additional Comments, below), the algorithm itself will achieve partitions (find subsets of historical data) that are simultaneously different with respect to the mean, while also achieving the smallest within-subsample variability (standard deviation) with respect to the performance index.
   7.3. Unlike the application of recursive partitioning algorithms in other domains, including discrete and continuous manufacturing domains, for the purposes of the invention disclosed here, it is critical that realistic parameter ranges be identified as those for which there is sufficient actual evidence in the historical data (i.e., which actually exist in the data). Thus, only candidate nodes (subsets of data identified through the application of recursive partitioning algorithms) are selected which contain a sufficient number of actual observed data (recordings), and typically, more than 5 percent of the historical data available (and prepared as described above) for the analyses.
8. In addition to the application of recursive partitioning algorithms, as described in 7 above, a multitude of other quantitative empirical modeler algorithms can be applied to derive predictive models of the quality performance indicator, such as support vector machines, naive Bayesian classifier algorithms, k-nearest neighbor methods, stochastic gradient boosting, or various methods for voting/averaging recursive partitioning algorithms.
   8.1. Each of these methods will allow for the computation of model-based predictions from the operational inputs.
   8.2. Then, by applying inverse prediction or optimization methods (by any of the standard methods for derivative free optimization, such as simplex optimization, genetic algorithm optimization, or stochastic optimization of operational parameter distributions, as commonly applied in risk modeling), while constraining the optimization algorithm to favor (simulated, optimized) operational parameter values similar (close in distance) to actual observed cases, solutions similar to those derived via recursive partitioning algorithms can be achieved.
   8.3. However, the primary advantage of using inverse prediction and optimization of algorithms-based prediction models is that interpolation and extrapolation from the actual observed historical data can be achieved, and controlled through the careful manipulation of the optimization constraints (how heavily optimal operational parameter solutions similar to the historical observed data are favored).
   8.4. This extension of the modeling and optimization approach therefore is useful to derive solutions when no actual subset of observation can be found in the historical data where satisfactory performance quality was achieved; instead, the optimization in this case is based on model-based predictions and expectations, which allow for further guided testing to verify expected (improved, according to the models and optimization) performance.
   8.5. Unlike applications of model based optimization strategies in other domains (such as data mining, risk and reliability optimization), the optimization here is specifically constrained and guided to converge on operational parameter settings that are close to and similar to operations actually achieved in the past, and recorded into the historical data.

Additional Comments

Recursive partitioning algorithms. Recursive partitioning algorithms are useful to partition observed data into multiple homogeneous subsamples, with the goal to extract “rules” that are associated with (“lead to”) desired outcomes. These algorithms are also sometimes called “decision trees” because the results of applying these algorithms can best be represented as a hierarchical tree, where consecutive splits (decision rules) lead to multiple branches and terminal nodes, so that the rules by which the observations are assigned to partitions (in each terminal node) can be expressed as a series of “decisions” or logical if-then statements (e.g., if “Coal Flow”>100 then Partion=1 else Partion=2).

A large number of such algorithms have been proposed and some are available in the form of software packages (see also Hill & Lewicki, 2006); some of the more popular algorithms are the Classification and Regression Trees algorithm (C&RT; Breiman, Friedman, Olshen, & Stone, 1984; see also Ripley, 1996), CHAID (Chi-squared Automatic Interaction Detector; see Ripley, 1996), C4.5 (Quinlan, 1992), QUEST (Loh & Shi, 1998), to name a few. Each of these algorithms aims at deriving decision rules from a set of input (predictor) variables, which when applied to a sample of data, will yield two or more subsamples (partitions) that are more homogeneous than the parent (non-divided) sample. Homogeneity is defined differently for discrete outcomes or continuous measurement outcomes or ranks; however, in general “homogeneity” is defined by some statistic that reflects simultaneously the dissimilarity of observations in different partitions, and the similarity of observations in the same partitions.

For example, a simple measure of homogeneity would be the mean difference for some continuous outcome measurement between two partitions, divided by the pooled (within-partitions) standard deviations. Thus, using this measure, the algorithm would produce partitions (subsamples) of the input data that would be as different (between partitions) on the respective outcome measurements as possible, while showing as little variability as possible within each partition.

In addition to recursive partitioning algorithms, a number of other algorithms are suitable for the method and system for process optimization disclosed here, such as support vector machines, naive Bayes classifiers, k-nearest neighbor methods, stochastic gradient boosting, or methods for voting/averaging the results of applying recursive partitioning algorithms to subsets of sampled data (see Hastie, Tibshirani, Friedman, 2001). Each of these computer algorithms will allow for the derivation of prediction models, relying on actual partitions (defined via nonlinear equations) in the observed data.

Listed below are some of the publications describing the specific details of computer data processing algorithms, which can be part of the specific method and system for boiler optimization disclosed in this patent.
Breiman, L., Friedman, J. H., Olshen, R. A., & Stone, C. J. (1984). Classification and regression trees. Monterey, Calif.: Wadsworth & Brooks/Cole Advanced Books & Software.
Hastie, T., Tibshirani, R., Friedman, J. H. (2001). The elements of statistical learning: Data mining, inference, and prediction. New York: Springer Verlag.
Hill, T. & Lewicki, P. (2006). Statistics: Methods and Applications. Tulsa, Okla.: StatSoft (available at Amazon.com)
Loh, W.-Y, & Shih, Y.-S. (1997). Split selection methods for classification trees. Statistica Sinica, 7, 815-840.
Ripley, B. D. (1996). Pattern Recognition and Neural Networks, Cambridge University Press
Quinlan. (1992). C4.5: Programs for Machine Learning, Morgan Kaufmann

### INDUSTRIAL APPLICABILITY

The methods disclosed here are applicable to any furnace and power plant where data are recorded describing the historical values of operational parameters.

The methods disclosed here are applicable not only to the performance of the actual boiler or furnace, but also to the operations of auxiliary systems and equipment, such as selective catalytic and non-catalytic NOx reduction systems (SCR, SNCR).

The methods disclosed here not only identify the ranges of operational parameters, where the process (boiler) performance is expected to be of high quality (as defined and disclosed in this patent), but also to identify the specific operational parameters which do not require tight and careful control, i.e., those which are not important to achieve consistent high-quality performance.

Other embodiments, features, aspects, and principles of the disclosed exemplary systems will be apparent to those skilled in the art and may be implemented in various environments and systems.

1. A method for identifying optimal operational parameter settings and ranges for digital controls systems or manual operator control system, controlling the operation of industrial furnaces, as used in the power industry for generating electricity, and associated equipment for environmental and emissions control integrated with industrial furnace operations, comprising of the steps of:
a) Extracting data from a database containing historical data describing all operational parameters and their values that were in effect during each particular time interval (for example, 1 minute time interval, or shorter), during furnace operations over an extended past time interval (for example, 1 year).
b) Assigning a numeric quality index to each time interval in the historical performance data of the furnace as described in 1.a above, based on a single performance criterion or the combination of a multitude of performance criteria, which may include but are not limited to NOx emissions, CO emissions, furnace exit gas temperature (FEGT), loss on ignition (LOI), measured flame temperature, and including but not limited to continuous quality indices, ordinal (rank-based) quality indices, or categorical (discrete) quality designators, such as “acceptable” vs. “unacceptable.”
b) Linking said performance to at least one operational (input) parameter or a multitude of operational (input) parameters that are controllable through the existing digital or manual control system.
c) Identifying at least one specific range of one operational input parameter, or a combination of a multitude of operational parameters, where, given the historical data, robust quality as identified in 1.b, with little variability in the numeric quality index, was observed and can be expected.

2. A method for identifying combinations of operational parameters, and their specific value ranges, where, given a single specific operational requirement or a multitude of specific operational requirements, including but not limited to furnace fuel flow, furnace exit gas temperatures, etc., quality performance as defined in 1.b has occurred and is evident in the historical data, and where the quality performance as defined in 1.b above showed relatively little variability while the combinations of operational parameters were set at said specified value ranges.

3. A method for identifying said operational parameter settings and ranges as in claim 1, or combinations of operational parameter settings and ranges as in claim 2, associated with consistent high-quality furnace performance as described in claim 1.b. in the historical data, by using quantitative empirical modeler algorithms including at least one data analysis technique selected from the group consisting of k-nearest neighbor, classification and regression tree (C&RT), chi-square automatic interaction detector (CHAID), decision trees, support vector machines, and the repeated application (boosting, voting or bagging) of these algorithms (to sampled subsets of data) to refine the solution

4. A method for selecting from among a multitude of empirical modeler algorithms those that yield the broadest applicability of the said operational parameter ranges (for optimal performance) to normal furnace operations, as identified in the historical data

5. A method for applying the results from the application of said statistical modeler algorithms described in 3 to the historical data describing furnace operations, to yield comprehensive operational recommendations for all operational parameters, to achieve high quality performance as defined in 1.b.
